(19) United States
(12) Patent Application Publication
(10) Pub. No.: US 2024/0078129 A1
(43) Pub. Date: Mar. 7, 2024

(54) EXECUTION OF BIOS COMPONENTS WITH VIRTUAL MACHINES

(71) Applicant: Hewlett-Packard Development Company, L.P., Spring, TX (US)

(72) Inventors: Christopher Howard Stewart, Spring, TX (US); Richard Alden Bramley, Jr., Mansfield, MA (US); James Misra McKenzie, Cambridge (GB); Krzysztof Tadeusz Uchronski, Cambridge (GB); Gianluca Guida, Cambridge (GB); Christopher Ian Dalton, Bristol (GB); Jeffrey Kevin Jeansonne, Spring, TX (US)

(73) Assignee: Hewlett-Packard Development Company, L.P., Spring, TX (US)

(21) Appl. No.: 18/262,168

(22) PCT Filed: Jan. 29, 2021
(86) PCT No.: PCT/US2021/015843

§ 371 Date: Jul. 19, 2023

(51) Int. Cl. G06F 9/455

(52) U.S. Cl. CPC G06F 9/45558; G06F 2009/45562; G06F 2009/4557; G06F 2009/45583

(57) ABSTRACT

An example non-transitory machine-readable medium includes instructions that cause a processor of a computing device to create a first virtual machine using a hypervisor, execute a trusted basic input/output system (BIOS) in the first virtual machine, create a second virtual machine using the hypervisor, and execute an untrusted BIOS component in the second virtual machine. The first virtual machine is executed with a greater privilege to access a resource of the computing device than the second virtual machine.

### BACKGROUND

Computing devices often include firmware such as a Basic Input/Output System (BIOS) stored in non-volatile memory. When a computing device is booted, the BIOS may initialize hardware of the computing device and start runtime services that may be used by an operating system or application executed by the computing device. A BIOS may also execute instructions provided by a hardware adapter, expansion card, graphics card, additional mainboard chip, or similar device, where such instructions may be known as an option ROM.

### BRIEF DESCRIPTION OF THE FIGURES

FIG. 1 is a block diagram of an example non-transitory machine-readable medium with instructions that launch a hypervisor to create virtual machines for isolated execution of a main BIOS program and a separate BIOS component.

FIG. 2 is a flowchart of an example method of isolated execution of a main BIOS program and a separate BIOS component using virtual machines and a hypervisor.

FIG. 3 is a flowchart of an example method of isolated execution of a BIOS and option ROMs using a hypervisor and virtual machines during pre-boot,

FIG. 4 is a block diagram of an example computing device that uses a hypervisor and virtual machines for isolated execution of a BIOS and option ROMs.

### DETAILED DESCRIPTION

Firmware instructions, such as a BIOS option ROM, provided to a computing device by a hardware adapter, expansion card, graphics card, mainboard chip, or similar device, may carry a risk of harm to the functionality of the computing device. An option ROM, for example, is often provided by the party that provides the specific hardware device that the option ROM concerns. This party is often different from the party providing the computing device and/or BIOS. Hence, the provider of the computing device and/or BIOS trusts the provider of the option ROM. Trust may be enforced by code review or the digital signing of the option ROM. While such techniques may reduce the risk of the option ROM crashing or causing poor performance in the computing device, they may require significant effort and vigilance and may be circumvented or disregarded.

Disclosed herein are techniques to execute an untrusted component of a BIOS (e.g., an option ROM) in a virtual machine, A trusted BIOS or trusted component thereof may be executed in a separate virtual machine. The virtual machines may be created and controlled by a trusted hypervisor, which may provide the virtual machines with different levels of privilege. An untrusted BIOS component may be granted a low level of privilege. Hence, if the untrusted BIOS component crashes, the BIOS and computing device may still operate as expected to the extent possible without the hardware device supported by the untrusted BIOS component. If the untrusted BIOS component contains malicious or harmful code, the reduced privilege level of the containing virtual machine may reduce the risk of harm.

In various examples, during pre-boot, the BIOS is started normally. Before any option ROM is executed, the BIOS launches a hypervisor that then virtualizes the BIOS. The hypervisor then virtualizes any option ROMs executed in their own separate virtual machines. Execution of the BIOS and option ROMs is isolated and privileged according to trust. The hypervisor manages communication between option ROMs and the BIOS, such as by controlling memory access or controlling calls made by an option ROM to a BIOS function. At the end of pre-boot, the hypervisor devirtualizes the BIOS and unloads itself, so that the operating system (OS) may be loaded normally.

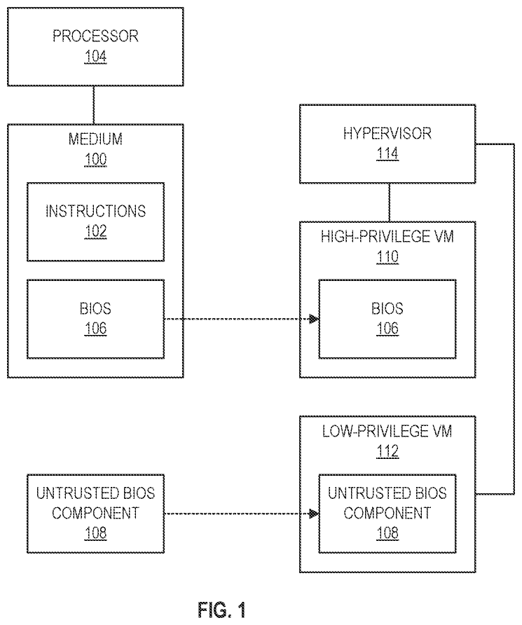

FIG. 1 shows an example non-transitory machine-readable medium 100. The medium 100 may include a non-volatile memory device, such as a flash memory, electrically erasable programmable read-only memory (EEPROM), or read-only memory (ROM), to store instructions 102 that are executable by a processor 104. The processor 104 may be a central processing unit (CPU) or a main processor of a computing device that also contains the medium 100.

The instructions 102 may launch a BIOS 106. The BIOS 106 may be stored in the medium 100 and may be executed by the processor 104. The instructions 102 may form part of the BIOS 106. The BIOS 106, instructions 102, or combination thereof may be referred to as firmware.

The medium 100, instructions 102, processor 104, and BIOS 106 may be provided to a computing device, such as a desktop computer, all-in-one (AIO) computer, notebook computer, or other computing device that may execute external instructions provided with a hardware device, such as an adapter or expansion card (e.g., a graphics card) installed in the computing device during manufacture, repair, or upgrade. Such external instructions may be provided by a party that provides the hardware component. Hence, the external instructions may be referred to as untrusted BIOS component 108 or option ROM, for example. Other examples of an untrusted BIOS component 108 include an OS bootloader.

The BIOS 106 is to initialize, control, or operate a computing device that contains the medium 100 prior to execution of the OS. Instructions included within the BIOS may include software, firmware, microcode, or other programming that defines or controls functionality or operation of the BIOS. In some examples, the BIOS may be implemented using instructions, such as platform firmware of a computing device, executable by a processor, such as a CPU of the computing device (e.g., processor 104). The BIOS may operate or execute prior to the execution of the OS of the computing device. The BIOS may initialize, control, or operate components such as hardware components of a computing device and may load or boot the OS of computing device.

In some examples, the BIOS 106 may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

The BIOS 106 causes external instructions (e.g., option ROM) to be executed by the processor 104 as part of normal initialization of the computing device. A BIOS component 108 provided with or by a hardware component may be shadowed into memory and executed, so as to initialize the hardware component and register the hardware component with the BIOS 106 during pre-boot.

In various examples, the untrusted BIOS component 108 is provided by a party different from the party that provides the BIOS 106. The BIOS 106, instructions 102, or both may be digitally signed by a trusted entity, so that the BIOS 106, instructions 102, or both may be considered trusted. Examples of a trusted entity that may digitally sign the BIOS 106, instructions 102, or both include the manufacturer of the computing device or the provider of the BIOS 106. The untrusted BIOS component 108 is not digitally signed by the same trusted entity and may instead be digitally signed by another entity. The trusted entity, particularly if manufacturing and/or selling the computing device, may be responsible for the proper functioning and reliability of the computing device, including the untrusted BIOS component 108.

The instructions 102 may prevent potentially harmful, malicious, or buggy code in the untrusted BIOS component 108 from harming or crashing the computing device or the BIOS 106 by creating separate first and second virtual machines 110, 112 to execute the BIOS 106 and the untrusted BIOS component 108, respectively. The BIOS 106 may be executed in its own first virtual machine 110 and the untrusted BIOS component 108 may be executed in its own second virtual machine 112. An additional BIOS component or other set of external instructions may be executed in an additional virtual machine 112. Any suitable number of virtual machines 112 may be used to isolate a corresponding number of different untrusted BIOS components 108 from the trusted BIOS 106.

The instructions 102 may launch a hypervisor 114 that creates and manages the virtual machines 110, 112. In various examples, the instructions 102 are included in the BIOS 106, so that the BIOS 106 itself launches the hypervisor 114, which then virtualizes the BIOS 106 to continue execution of the BIOS 106. After the untrusted BIOS component 108 completes execution, the instructions 102 may devirtualize the BIOS 106 and halt the hypervisor 114. In various examples, the hypervisor 114 devirtualizes the BIOS 106 at about the same time or just after the BIOS 106 invokes an OS bootloader. The hypervisor 114 then unloads itself. The creation, usage, and destruction of the virtual machines 110, 112 may be limited to the time before the OS is booted.

The hypervisor 114 may provide a greater privilege to access a given resource of the computing device to the first virtual machine 110 that contains the BIOS 106 as compared to a second virtual machine 112 the contains an untrusted BIOS component 108. Privilege may control access to the memory of the computing device (e.g., random-access memory or RAM), a CPU register, or similar resource. Privilege may specify discrete rules for different types of access that are allowed/disallowed, such as read, write, and execution. Privilege may accord to a scheme, such as hierarchical protection domains or protection rings. The hypervisor 114 itself may be executed with elevated privilege that is equal to or greater than the privilege of the virtual machine 110 that executes the first virtual machine 110 that contains the trusted BIOS 106.

An example resource that is made accessible to the BIOS 106 via the high-privilege virtual machine 110 is the working memory of the computing device. The BIOS 106, being trusted, may be granted a high-degree of access or unlimited access to memory. The untrusted BIOS component 108, however, may be granted limited access to the memory by the low-privilege virtual machine 112.

The degree of resource access provided by the virtual machines 110, 112 may be controlled by the hypervisor 114. The limited access provided to the low-privilege virtual machine 112 may be based on the expected functionality of the untrusted BIOS component 108. For example, an untrusted BIOS component 108 provided for a graphics card may require access to graphics-related data in an advanced configuration and power interface (ACPI) table. As such, the hypervisor 114 may grant the low-privilege virtual machine 112 access to the memory location containing the relevant ACPI table data and prohibit access other areas of memory. At the same time, the hypervisor 114 may allow general memory access by the high-privilege virtual machine 110 that contains the trusted BIOS 106.

The hypervisor 114 may control the memory used by each virtual machine 110, 112, so that each virtual machine 110, 112 has no knowledge of the memory used by the other virtual machine 110, 112. For example, each virtual machine 110, 112 may be assigned its own set of virtual memory addresses. All sets of virtual memory addresses may be known only to the hypervisor 114. Hence, if a virtual machine 110, 112 attempts to access a memory address outside its assigned memory space, the computing device may raise a page fault to the hypervisor 114. The hypervisor 114 then allows or denies access to the memory address or takes other action. Allowing access to the memory address may include mapping the page containing the requested memory address to the set of virtual memory addresses assigned to the virtual machine. The hypervisor 114 may perform such a mapping using a memory page table. This may be controlled at the hardware level (e.g., via a memory management unit or MMU of the computing device). As such, the hypervisor 114 may control access by the BIOS 106 and the untrusted BIOS component 108 to the memory of the computing device. The hypervisor 114 may further arbitrate the sharing of data or communication between the BIOS 106 and untrusted BIOS component 108.

The hypervisor 114 may allow/deny access to memory or other resource silently, with a user notification, or with a user prompt to allow/deny a proposed action, according to any suitable methodology. Various combinations of allowing/denying specific types of memory access, and doing so with or without alerting the user or requesting the user's permission, are contemplated. Several examples are mentioned below and discussed elsewhere herein.

In some examples, an untrusted BIOS component 108 is provided by a graphics card and includes instructions that access to ACPI table data. The hypervisor 114 starts a low-privilege virtual machine 112 and virtualizes the untrusted BIOS component 108 in the virtual machine 112. During execution of the untrusted BIOS component 108, when access to ACPI table data is made, the hypervisor 114 receives a page fault and, in response, determines whether or not such memory access is to be granted. The hypervisor 114 may make such determination using any suitable criteria, such as by referencing an indication that the untrusted BIOS component 108 relates to a graphics card. The hypervisor 114 may determine that access to ACPI table data is expected functionality of a graphics card and accordingly may map the relevant area of memory to the virtual machine 112.

In some examples, the BIOS 106 may provide a function that may be called by untrusted BIOS components 108, so that various untrusted BIOS components 108 need not provide redundant implementations of the function. A particular untrusted BIOS component 108 operating in a low-privilege virtual machine 112 may contain a reference to such a function and but may not have access to the region of memory that stores the instructions that implement the function. When the untrusted BIOS component 108 is executed and calls the function, the hypervisor 114 receives a page fault. In response, the hypervisor 114 may determine whether or not access to the memory area that contains the function is to be granted. If access is to be granted, then the hypervisor 114 maps the relevant region of memory to the virtual machine 112.

In other examples concerning a function call, the hypervisor 114 may determine that access is granted to the function, as above, and then the hypervisor 114 may invoke the requested function on behalf of the requesting untrusted BIOS component 108. That is, the hypervisor 114 may act as an intermediary for the function call by marshalling data between virtual machines, for example, by passing any parameter for the function from the calling virtual machine to the virtual machine that has the function and passing any returned value back to the calling virtual machine. For example, the hypervisor 114 having knowledge of the memory used by both the calling and called virtual machines, may detect a function call (with any parameter) by the calling virtual machine by way of a page fault. The hypervisor 114 may then itself call the function at the called virtual machine by, for example, making a memory access to the location where the function is stored. The hypervisor 114 may then obtain a return value of the function, if any, from a memory location indicated by the function. Finally, the hypervisor 114 may place the return value in memory accessible to the calling virtual machine and signal to the calling virtual machine that the return value of the function is at such location. This approach may be used in combination with the approach discussed above that grants access to the relevant region of memory.

In some examples, an untrusted BIOS component 108 may be prohibited from all memory access and the hypervisor 114 may process a page fault by requesting permission from the user to allow the untrusted BIOS component 108 to access memory.

As such, the virtual machines 110, 112 allow for isolation of execution of potentially harmful code, which may be provided in an option ROM, while the hypervisor 114 may provide for control of interactions of untrusted code with the resources of the computing system and the trusted BIOS.

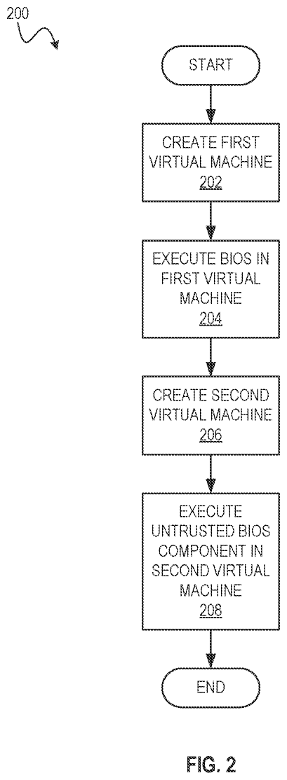

FIG. 2 shows an example method 200 of isolated execution of a BIOS and a BIOS component using virtual machines as created and controlled by a hypervisor. The BIOS may be trusted and thus executed in a virtual machine with privileged access to memory or other resource, while the BIOS component may be untrusted and thus executed in a virtual machine as unprivileged or with otherwise reduced privilege compared to the BIOS. The method 200 may be implemented by processor-executable instructions stored in a non-transitory machine-readable medium of a computing device.

At block 202, a hypervisor creates a first virtual machine. The hypervisor may be launched by a trusted BIOS or may be launched prior to launch of the BIOS. The hypervisor may allocate a region of working memory (e.g., RAM) to the first virtual machine. The hypervisor may respond to page faults triggered by the first virtual machine by mapping the requested memory to the memory assigned to the virtual machine, such as by modifying a page table.

At block 204, the trusted BIOS is executed in the first virtual machine. The BIOS may detect an untrusted BIOS component, such as an option ROM provided by a hardware device of the computing device, such as an expansion card added to the computing device. The BIOS may copy a detected untrusted BIOS component into a location of working memory of the computing device. The hypervisor allows the first virtual machine write access to this location of memory. The hypervisor may further disallow execution of this location of memory by the first virtual machine, so as to cause a page fault or other exception when the BIOS attempts to execute the untrusted BIOS component.

At block 206, the hypervisor creates a second virtual machine and may allocate a separate region of working memory to the second virtual machine. Block 206 may be performed in response to the BIOS attempting to execute this untrusted BIOS component in the working memory. As the location of memory that stores the untrusted BIOS component is not executable by the first virtual machine, a page fault or other exception may be detected by the hypervisor. In response, the hypervisor may create the second virtual machine and execute the untrusted BIOS component in the second virtual machine, at block 208.

The second virtual machine is granted a lower privilege than the first virtual machine. For example, during execution of the untrusted BIOS component, at block 208, the hypervisor may respond to page faults triggered by the second virtual machine by controlling memory access based on the purpose of the untrusted BIOS component.

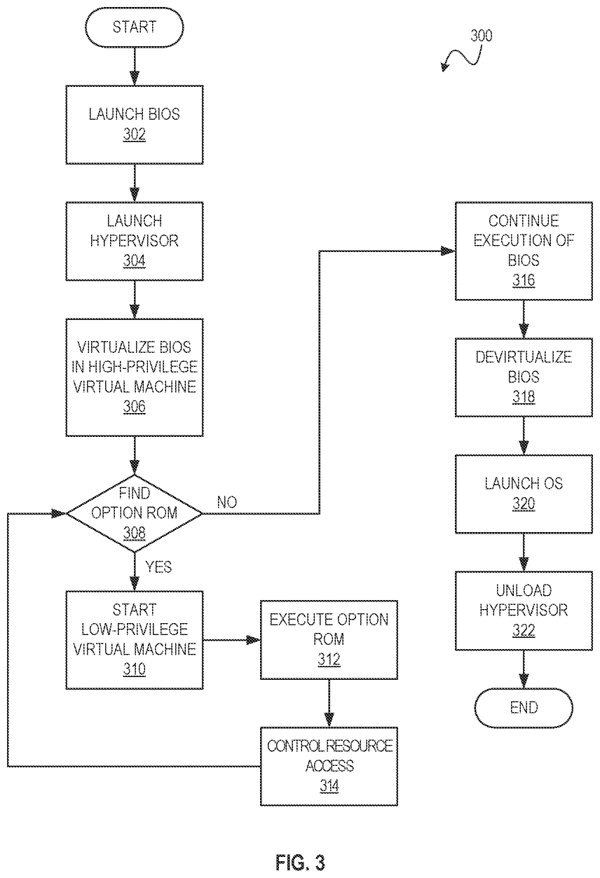

FIG. 3 shows an example method 300 of isolated execution of a BIOS and option ROMs using a hypervisor and virtual machines during pre-boot of a computing device. The BIOS may be trusted and thus executed in a virtual machine with privileged access to memory or other resource of the computing device. The option ROM may be provided by another party and therefore executed in a virtual machine as unprivileged or with otherwise reduced privilege compared to the BIOS. The method 300 may be implemented by processor-executable instructions stored in a non-transitory machine-readable medium of a computing device.

At block 302, the BIOS is launched. This may occur immediately after a power on or reset operation of the computing device.

At block 304, the BIOS launches a hypervisor. The hypervisor may be a separate program and the BIOS may include a command that launches it. The BIOS and hypervisor are both trusted components of the computing device.

At block 306, the hypervisor creates a high-privilege virtual machine and virtualizes the BIOS in that virtual machine. After virtualizing the BIOS, the hypervisor may instruct the BIOS to continue execution at the point left off prior to launch of the hypervisor. The BIOS continues its execution within the high-privilege virtual machine.

At block 308, as part of its normal operation, the BIOS scans the computing device for option ROMs that may be provided with externally provided hardware devices, such as a video card, or that may be provided in a chip on the mainboard. If no option ROMs are found, the BIOS continues and completes execution, at block 316.

For each option ROM found, at block 308, the hypervisor starts a low-privilege virtual machine, at block 310, and launches the option ROM in the low-privilege virtual machine. To achieve this, the hypervisor may detect that the high-privilege virtual machine executing the BIOS has requested access to a memory space for the purpose of running option ROMs. For example, the high-privilege virtual machine may attempt to copy an option ROM to RAM and then execute the option ROM. This memory access may be detected by the hypervisor, for example by way of a page fault, so that the hypervisor can take control, create the low-privilege virtual machine, and run the option ROM in the low-privilege virtual machine.

At block 312, the option ROM executes in the low-privilege virtual machine and the hypervisor controls any resource requests, such as triggered by page faults, according to a limited privilege consistent with the functionality provided by the option ROM and related hardware device, at block 314. For example, if the option ROM was provided by a video card, the hypervisor may allow the low-privilege virtual machine access to an area of memory that stores an ACPI table, so that a graphics processor can be properly initialized and registered. All other memory access may be denied by the hypervisor. In other examples, such as an option ROM that calls a function provided by the BIOS, the hypervisor may allow limited (e.g., read-only) access to the memory space that stores that function. In various examples, the hypervisor may alert the user of the computing device as to a resource requested by an option ROM and/or prompt the user to allow or deny such requests.

After execution of all discovered option ROMs, the BIOS may continue to execute, at block 316.

At block 318, after the option ROMs are complete, the hypervisor devirtualizes the BIOS. This may be done any time before the end of execution of the BIOS. The BIOS may be programmed to set a flag that is watched by the hypervisor to signal that the BIOS is ready to be devirtualized. Additionally or alternatively, the hypervisor may monitor execution activity by the high-privileged virtual machine and, when execution ceases, determine that the BIOS has finished.

In various examples, the hypervisor devirtualizes the BIOS immediately before the completion of execution of the BIOS during POST. In UEFI systems, this may occur immediately prior to the return of the UEFI Boot Services function (e.g., ExitBootServices). In examples of such systems, an option ROM may need to be available until the point just before completion of execution of the BIOS because the OS bootloader may need access to video, networking resources, or other resources provided by the option ROM in the pre-OS environment.

At block 320, the BIOS launches the OS bootloader to launch the OS, so that the OS may be started normally.

At block 322, the hypervisor unloads itself, as the virtualized environment is no longer required.

In various examples, such as UEFI implementations, blocks 320 and 322 are generally performed in the order described. The hypervisor may unload itself (block 322) at the return point of a UEFI Boot Services function (e.g., ExitBootServices). For example, while the hypervisor is still running, the trusted BIOS launches the OS bootloader (block 320), which may execute in its own low-privilege virtual machine created by the hypervisor (e.g., as if the bootloader were an option ROM). Alternatively, the trusted BIOS may launch the OS bootloader in the same virtual machine as the trusted BIOS if, for instance, the OS bootloader is as trusted as the trusted BIOS (e.g., digitally signed by the same key or an equivalently secure key). The OS bootloader then executes its code. In UEFI implementations, the OS bootloader may include UEFI code and may operate as if it were an option ROM. During its execution, the OS bootloader calls the trusted BIOS by, for example, calling a UEFI Boot Services function (e.g., ExitBootServices). In examples where the OS bootloader runs in a virtual machine separate from the virtual machine that runs the trusted BIOS, then this invocation is marshalled in the same way as a function call and/or data marshaling that is performed for an untrusted BIOS component (e.g., option ROM), as described above. If the OS bootloader is running in the trusted virtual machine that also runs the BIOS, then there is no such marshaling performed. In both examples, registered UEFI Boot Services functions in the trusted BIOS may execute. If an option ROM has registered a UEFI Boot Services function callback, the callback will execute in the virtual machine that contains the option ROM. Finally, the UEFI Boot Services function returns and the hypervisor unloads (block 322).

The hypervisor and virtual machines are no longer used, and their resources may be freed if not already freed. The hypervisor and virtual machines therefore have no effect on execution of the OS.

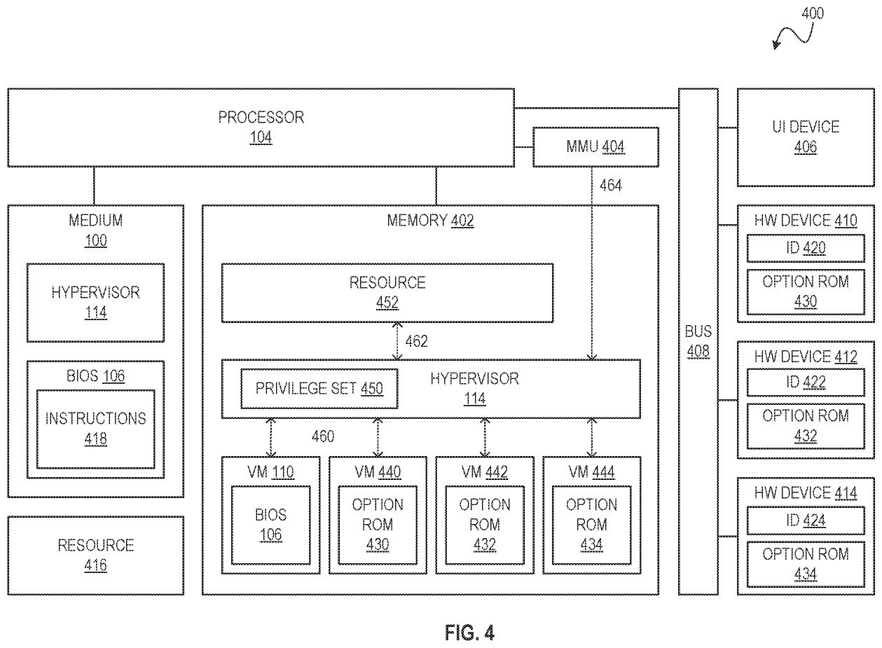

FIG. 4 shows an example computing device 400. The computing device may be a desktop computer, AIO computer, notebook computer, or other computing device that may execute external instructions provided with a hardware device, such as an expansion card or a chip installed at the mainboard. Such external instructions may be referred to as option ROMs and may supplement the functionality of the BIOS of the computing device 400. The description of the medium 100 discussed above may be referenced for detail not repeated below, with like terminology and reference numerals denoting like components.

The computing device 400 includes hardware such as a non-transitory machine-readable medium 100, processor 104, memory 402, MMU 404, user interface (UI) device 406, a bus 408, and a hardware device 410, 412, 414. The bus 408 may connect the processor 104 to the hardware device 410, 412, 414. Any suitable number of hardware devices 410, 412, 414 may be provided, with three merely being an example. The computing device 400 may further include an additional hardware resource, such as processor registers, indicated generally at 416.

The medium 100 may be a non-volatile memory device that stores instructions that implement a BIOS 106 and hypervisor 114. The BIOS 106, in addition to its normal instructions, may include instructions 418 that launch the hypervisor 114.

The memory 402 is volatile working memory and includes RAM or similar memory device, Memory 402 may further include a non-volatile device, such as a hard disk drive (HDD) or solid-state drive (SSD) for use if the RAM has insufficient capacity.

The MMU 404 manages access to the memory 402 and may store page tables and raise an exception, for example, a page fault, if a process requests memory outside what is already assigned.

The user interface device 406 may include an input and/or output device, such as a keyboard, display device, speaker, mouse, or similar. The user interface device 406 allows for alerts or notifications to be provided to the user. The user interface device 406 may allow for the user to respond to a prompt by providing an input.

The bus 408 provides communications between the processor 104 and other components of the computing device 400 that do not have direct connections to the processor 104. The bus 408 may be a peripheral component interconnect express (PCIe) bus.

The hardware devices 410, 412, 414 may include expansion cards that provide additional functionality to the computing device 400, Examples of expansion cards are discussed elsewhere herein and include video/graphics cards, network adaptors, and similar. A hardware device 410, 412, 414 may be a PCIe card that connects to the bus 408. Another example of a hardware device 410, 412, 414 includes a chip that is directly installed on a mainboard that carries the processor 104.

A hardware device 410, 412, 414 may include a respective identifier 420, 422, 424 and a respective instruction component, which may include firmware or read-only instructions and may be referred to as an option ROM 430, 432, 434, The identifier 420, 422, 424 may identify the functionality provide by the respective hardware device 410, 412, 414 and, for example, may include a class code or subclass or similar data set out by PCIe or other communications specification. For example, the identifier 420, 422, 424 may specify that the respective hardware device 410, 412, 414 is a video card, network card, or similar. The identifier 420, 422, 424 may additionally or alternatively include a vendor identifier, so trust can be granted based on party or source. The option ROM 430, 432, 434 includes code that is executable by the processor 104 to initialize and register the respective hardware device 410, 412, 414.

The BIOS 106, which may be referred to as the firmware, is executed when the computing device 100 starts, during pre-boot of the computing device 400. The BIOS 106 and hypervisor 114 may be considered trusted, while the option ROMs 430, 432, 434 may be considered untrusted.

During BIOS 106 execution and before an option ROM 430, 432, 434 is executed, the instructions 418 launch the hypervisor 114. The hypervisor 114 contains instructions to virtualize the BIOS 106 in a virtual machine 110. During continued execution of the BIOS 106 within its virtual machine 110, the BIOS 106 may detect the option ROMs 430, 432, 434 provided by the hardware devices 410, 412, 414 connected to the bus 408. The option ROMs 430, 432, 434 are executed in additional respective virtual machines 440, 442, 444.

The hypervisor 114 may include a privilege set 450 that is used to allow or deny requests by the virtual machines 110, 440, 442, 444 to resources of the computing device, including a memory resource 452 or a hardware resource 416. The privilege set 450 may grant high privilege to the virtual machine 110 that runs the BIOS 106 and low privileges to the virtual machines 440, 442, 444 that run the option ROMs 430, 432, 434. A privilege of a particular option ROM 430, 432, 434 may be assigned according to the identifier 420, 422, 424 of the respective hardware device 410, 412, 414. For example, a video card may be granted access to a specific memory resource 452, such as an ACPI table or portion thereof, while a network card may not. The hypervisor 114 itself may operate at the highest level of privilege and thus be able to freely access all resources 416.452.

Access by the virtual machines 110, 440, 442, 444 to each other and to resources 452, 416 is controlled by the hypervisor 114, as generally indicated by communication 460 between the hypervisor 114 and the virtual machines 110, 440, 442, 444 and by communication 462 between the hypervisor 114 and the resource 452. The BIOS 106 or an option ROM 430, 432, 434 may require information from another of the BIOS 106 or an option ROM 430, 432, 434 or from a memory resource 452 or other resources 416. Such requests for information may be made by memory accesses, which may be controlled by the MMU 404 and its page tables. The MMU may raise a page fault 464 to the hypervisor 114 when the memory privileges of the requesting virtual machine 110, 440, 442, 444 are insufficient. As such, the hypervisor 114 may evaluate the request against the privilege set 450 to allow or deny the request with or without alerting the user or requesting user approval via the UI device 406.

The hypervisor 114 is aware of the contents of the virtual machines 110, 440, 442, 444 as it creates them. The hypervisor 114 make track a particular program (e.g., BIOS or portion ROM) that is assigned to a particular virtual machine 110, 440, 442, 444. The hypervisor 114 may then correlate the particular program to the permission set 450 when considering a request by the respective virtual machine 110, 440, 442, 444. The page fault mechanism is useful in for the hypervisor 114 to monitor such resource requests. The hypervisor 114 may then grant or deny access to the requested resource, and the default may be to deny. Further, it should be apparent that individual option ROMs 430, 432, 434 may be provided with various degrees of trust ranging from untrusted to trusted. A specific ROM 430, 432, 434 may be given a particular privilege as governed by the hypervisor 114, which is trusted.

In various examples discussed above, multiple untrusted option ROMs execute in theft own separate and isolated low-privilege virtual machines, an OS bootloader executes in its own separate and isolated low-privilege virtual machine, and trusted BIOS code executes in its own separate and isolated high-privilege virtual machine. In other examples, multiple untrusted option ROMs execute in their own separate and isolated low-privilege virtual machines and an OS bootloader and trusted BIOS execute in a separate and isolated high-privilege virtual machine. Communication of data between virtual machines may be controlled by a hypervisor and, when allowed, may be provided by the hypervisor mapping memory resources in response to page faults or by the hypervisor marshalling data between the virtual machines.

In view of the above, it should be apparent that virtual machines may be used to isolate pre-boot operations of a computing device, specifically, the execution of a trusted and untrusted components of the BIOS. A hypervisor may control access of such components to resources of the computing device. Crashes and malicious or harmful code may be isolated. The overall functioning of the computing device may be made more reliable.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that cause a processor of a computing device to:
create a first virtual machine using a hypervisor;
execute a trusted basic input/output system (BIOS) in the first virtual machine;
create a second virtual machine using the hypervisor; and
execute an untrusted BIOS component in the second virtual machine;
wherein the first virtual machine is executed with a greater privilege to access a resource of the computing device than the second virtual machine.

2. The non-transitory machine-readable medium of claim 1, wherein:
the hypervisor is to execute the second virtual machine with limited access to a memory resource of the computing device; and
the limited access is provided by the hypervisor based on expected functionality of the untrusted BIOS component.

3. The non-transitory machine-readable medium of claim 1, wherein the trusted BIOS is to launch the hypervisor before the trusted BIOS is executed in the first virtual machine.

4. The non-transitory machine-readable medium of claim 3, wherein;
multiple untrusted BIOS components are executed in multiple separate second virtual machines;
the multiple untrusted BIOS components include an option ROM provided by a hardware device added to the computing device and an operating system (OS) bootloader; and
the hypervisor is to devirtualize the trusted BIOS and unload the hypervisor after the trusted BIOS invokes the OS bootloader.

5. The non-transitory machine-readable medium of claim 3, wherein:
the untrusted BIOS component includes an option ROM provided by a hardware device added to the computing device;
a trusted operating system (OS) bootloader is executed in the first virtual machine with the trusted BIOS; and
the hypervisor is to devirtualize the trusted BIOS and unload the hypervisor after the trusted BIOS invokes the OS bootloader.

6. The non-transitory machine-readable medium of claim 1, wherein the hypervisor is to control memory access by the untrusted BIOS component.

7. A computing device comprising:
a bus;
a processor connected to the bus; and
firmware executable by the processor, wherein the firmware is to cause the processor to, during a pre-boot of the computing device, execute the firmware in a first virtual machine, detect instructions provided by a hardware device connected to the bus, execute the instructions provided by a hardware device in a second virtual machine that has a lower privilege than the first virtual machine.

8. The computing device of claim 7, wherein the firmware is to launch a hypervisor that is to create the first and second virtual machines and further that is to virtualize the firmware in the first virtual machine.

9. The computing device of claim 8, wherein the hypervisor is to devirtualize the firmware from the first virtual machine before the end of the pre-boot of the computing device.

10. The computing device of claim 7, wherein the instructions provided by the hardware device comprise an untrusted option ROM.

11. The computing device of claim 7, further comprising a memory connected to the processor, wherein the second virtual machine has a lower privilege of access to the memory than does the first virtual machine.

12. A non-transitory machine-readable medium comprising instructions that cause a processor of a computing device to:
implement a basic input/output system (BIOS) of a computing device;
implement a hypervisor that Is launched by the BIOS; and
wherein the hypervisor is to virtualize the BIOS in a high-privilege virtual machine; and
wherein the hypervisor is to virtualize an instruction component of a hardware device of the computing device in a low-privilege virtual machine to initialize the hardware device and register the hardware device with the BIOS.

13. The non-transitory machine-readable medium of claim 12, wherein the BIOS is to launch the hypervisor during a pre-boot of the computing device.

14. The non-transitory machine-readable medium of claim 12, wherein the hypervisor is to manage communication between the BIOS and the instruction component of the hardware device.

15. The non-transitory machine-readable medium of claim 12, wherein the hypervisor is to devirtualize the BIOS from the high-privilege virtual machine after execution of the instruction component of the hardware device.
